(19) United States
(12) Patent Application Publication
(10) Pub. No.: US 2014/0186647 A1
(43) Pub. Date: Jul. 3, 2014

(54) BROAD PARTICLE SIZE DISTRIBUTION POWDERS FOR FORMING SOLID OXIDE FUEL CELL COMPONENTS

(71) Applicant: Saint-Gobain Ceramics & Plastics, Inc., Worcester, MA (US)

(72) Inventors: Aravind MOHANRAM, Northborough, MA (US); Yeshwanth NARENDAR, Westford, MA (US); John D. PIETRAS, Sutton, MA (US)

(73) Assignee: Saint-Gobain Ceramics & Plastics, Inc., Worcester, MA (US)

(21) Appl. No.: 14/107,893

(22) Filed: Dec. 16, 2013

Related U.S. Application Data
(60) Provisional application No. 61/746,471, filed on Dec. 27, 2012.

(51) Int. Cl. H01M 4/90

(52) U.S. Cl. CPC H01M 4/9016; H01M 4/905
USPC 428/546; 423/263; 423/594.19; 420/441; 428/402

(57) ABSTRACT

A raw material powder for forming a layer of a solid oxide fuel cell (SOFC) article includes a broad particle size distribution (BPSD) defined by plotted curve of frequency versus diameter of the raw material powder may be characterized as having a first standard deviation including at least about 78% to at least about 99% of a total content of particles of the raw material powder. The plotted curve of the BPSD may also be characterized as having a first maximum value and a first minimum value, wherein the difference between the first maximum value and first minimum value is not greater than about 8%.

### CROSS-REFERENCE TO RELATED APPLICATION(S)

The present application claims priority from U.S. Provisional Application No. 61/746,471, filed Dec. 27, 2012, entitled “Broad Particle Size Distribution Powders for Forming Solid Oxide Fuel Cell Components,” naming inventors Aravind Mohanram, Yeshwanth Narendar, and John D. Pietras, which application is incorporated by reference herein its entirety.

### FIELD OF THE DISCLOSURE

The following is directed to solid oxide fuel cells (SOFCs) and methods of forming SOFCs, and more particularly, to a raw material powder having a broad particle size distribution useful in forming components of SOFCs.

### DESCRIPTION OF THE RELATED ART

A fuel cell is a device that generates electricity by a chemical reaction. Among various fuel cells, solid oxide fuel cells (SOFCs) use a hard, ceramic compound metal (e.g., calcium or zirconium) oxide as an electrolyte. In some instances, fuel cell assemblies have been designed as cells, which can include a cathode, anode, and solid electrolyte between the cathode and the anode. Each cell can be considered a subassembly, which can be combined in stacks with other cells to form a full SOFC article. In assembling the SOFC article, electrical interconnects can be disposed between the cathode of one cell and the anode of another cell.

However, SOFCs can be susceptible to damage caused during their formation that can affect function. In particular, materials employed to form the various components of an SOFC, including ceramics of differing compositions employed to form the anode functional layer, exhibit distinct material, chemical, and electrical properties that, if not selected properly, can result in breakdown (degradation) of the anode functional layer and poor performance or failure of the SOFC article.

The industry continues to demand improved SOFC articles and methods of forming.

### SUMMARY

According to one aspect, a raw material powder configured to form a portion of a layer of a solid oxide fuel cell (e.g. an anode functional layer) has a broad particle size distribution (BPSD) defined by a plotted curve of frequency versus diameter of the raw material powder, wherein the BPSD is defined by a first standard deviation including at least about 78% of a total content of particles of the raw material powder. The first standard deviation can include up to at least about 99% of the raw material powder. The BPSD can further be defined by a second standard deviation including at least about 98% of the total content of particles of the raw material powder. The difference between the first standard deviation and the second standard deviation can be less than about 17% to less than about 1%.

In another aspect, the BPSD can include a local region, the local region defining a portion of the plotted curve between a first maximum frequency value, F1ₘₐₓ, and a second maximum frequency value, F2ₘₐₓ. The local region may further comprise at least one minimum frequency value, F1ₘᵢₙ, between F1ₘₐₓ and F2ₘₐₓ. In at least one embodiment, F1ₘₐₓ may define a point on the plotted curve having a tangent line having a slope of 0, and may be located between a first portion of the plotted curve having a positive slope and a second portion of the plotted curve having a negative slope, the first portion being adjacent to the second portion and closer to the origin than the second portion. In at least one embodiment, F2ₘₐₓ is different from and defines a point on the plotted curve having a tangent line having a slope of 0, and located between a third portion and a fourth portion, the third portion being adjacent to the fourth portion and closer to the origin than the fourth portion. In at least one embodiment, F1ₘᵢₙ may define a point on the plotted curve having a tangent line having a slope of 0, and located between the first portion and the fourth portion.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a solid oxide fuel cell (SOFC) according to an embodiment.

FIG. 2 includes a graph of a particle size distribution (PSD) of a raw material powder having a normal distribution.

FIG. 3 includes a graph of a particle size distribution (PSD) of a raw material powder having a broad particle size distribution (BPSD) according to an embodiment.

FIG. 4 includes a graph illustrating an embodiment of a particle size distribution (PSD) of a raw material powder having a broad particle size distribution (BPSD) according to an embodiment.

FIG. 5 includes a graph of particle size distributions (PSD) of exemplary raw material powders “A,” “B,” and “C.”

The use of the same reference symbols in different drawings indicates similar or identical items.

### DETAILED DESCRIPTION

A solid oxide fuel cell (SOFC) can include a cathode, anode, and solid electrolyte between the cathode and the anode. The cathode, anode, and electrolyte can be formed as layers. The cathode and anode layers may each include a bulk layer and a functional layer, wherein the functional layer can be between and in direct contact with its respective bulk layer and the electrolyte. For instance, the anode functional layer (AFL) can be between and in direct contact with the anode bulk layer (ABL) and the electrolyte of the SOFC.

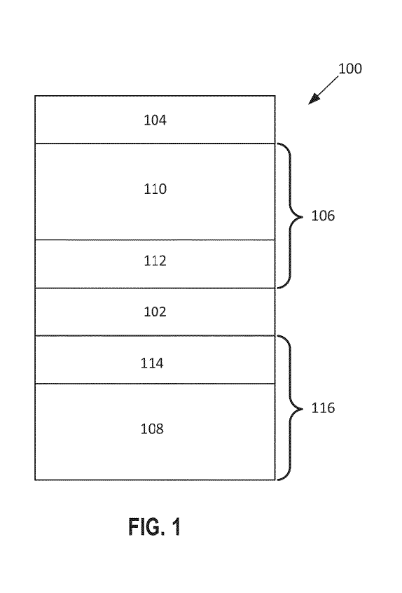

FIG. 1 includes an illustration of a SOFC unit cell 100 in accordance with an embodiment. SOFC unit cell 100 can include an interconnect layer 104, an anode 106, an electrolyte layer 102, and a cathode 116. In accordance with the embodiment illustrated in FIG. 1, anode 106 can include an anode bulk layer (ABL) 110 and an anode functional layer (AFL) 112, and cathode 116 can include a cathode bulk layer (CBL) 108 and a cathode functional layer (CFL) 114. As shown in the embodiment of FIG. 1, AFL 112 is disposed between ABL 110 and electrolyte layer 102, while CFL 114 is disposed between CBL 108 and electrolyte layer 102. While an interconnect layer may be disposed on either the anode or cathode on the side of anode or cathode opposite the electrolyte, the embodiment of FIG. 1 shows interconnect 104 disposed on the side of ABL 110 of anode 106.

In accordance with an embodiment, anode 106 may include anode bulk layer (ABL) 110 and anode functional layer (AFL) 112. In particular, AFL 112 can facilitate suitable electrical and electrochemical characteristics of the finished SOFC article, and improve electrical and mechanical connection between anode 106 and electrolyte 102. AFL 112 can be in direct contact with electrolyte layer 102. More particularly, AFL 112 can be directly bonded to electrolyte layer102.

Typically, in solid oxide fuel cells, an oxygen gas, such as O₂, is reduced to oxygen ions (O²⁻) at the cathode, and a fuel gas, such as H₂ gas, is oxidized with the oxygen ions to form water at the anode. The anode provides reaction sites for the electrochemical oxidation of the fuel gas. It is preferred that the anode material be stable in the reducing environment and have sufficient electronic and ionic conductivity, catalytic activity for the fuel/gas reaction under operating conditions, gas diffusion, and chemical and physical compatibility with surrounding components such as an electrolyte layer or an interconnect layer.

In order to facilitate the anode kinetics, it is typically desirable to include a large number of triple point boundary (TPB) sites for the fuel-oxidation reaction. The TPB sites are typically concentrated in the anode functional layer (AFL) of the anode, a typically thin layer between in direct physical contact with the anode bulk layer (ABL) and the electrolyte. A porous anode structure helps ensure that the gaseous reactants will diffuse into the TPB sites.

However, SOFCs can be susceptible to damage caused during their formation that can affect the TPB sites. In particular, materials employed to form the various components of an SOFC, including ceramics of differing compositions employed to form the anode functional layer, exhibit distinct material, chemical, and electrical properties that, if not selected properly, can result in breakdown (degradation) of TPB sites and poor performance or failure of the SOFC article.

In an embodiment, a raw material powder may be used for forming a portion of a layer of a solid oxide fuel cell. In an embodiment, one or more layers of the SOFC may include a raw material powder that is a green material. It will be understood to one of ordinary skill in the art that a powder can be a collection of particles, and that a raw material powder is a collection of unfired particles, termed herein as a green material. In an embodiment, the raw material powder can include yttria stabilized zirconia (YSZ). In another embodiment, the raw material powder can include nickel and/or nickel oxide. In yet another embodiment, the raw material powder can include a combination of YSZ and nickel and/or nickel oxide.

In an embodiment, the raw material powder can be formed of a relatively fine agglomerated or unagglomerated powder. Additionally, the powder can be a mixture of agglomerated and unagglomerated powders, wherein the unagglomerated powder may have a notably finer particle size. Such sizes can facilitate formation of suitable pore sizes and grain sizes within a layer of the SOFC of an embodiment.

In an embodiment, a functional layer, such as anode functional layer (AFL) 112, may be formed from a raw material powder, and may be formed separately or in conjunction with other layers of an SOFC, such as through tape casting, sintering, hot-pressing, co-sintering, or other methods known in the art, alone or in combination. For example, the SOFC unit cell 100 can represent a plurality of layers that are stacked together prior to thermal treatment and a plurality of layers integrally formed together after conducting a single sintering process (e.g., a single, free-sintering or pressure-assisted sintering process).

In an embodiment, ABL 110 and AFL 112 may include the same material(s). However, the material(s) may be adjusted or selected for content percentage, particle size, porosity, and/or processing to provide characteristics (e.g., porosity, electrical and chemical conductance, layer strength) suitable for each layer. For example, AFL 112 can have an average pore size that is significantly smaller than an average pore size of pores within ABL 110. According to an embodiment, AFL 112 can have a porosity within a range between about 20 vol % and about 50 vol %, for the total volume of the AFL 112.

The raw material powder may include a variety of particle sizes at the upper and lower limits of a range of particle sizes. In one embodiment, the raw material powder may include particle sizes not greater than about 50 μm, not greater than about 40 μm, not greater than about 30 μm, not greater than about 20 μm. In another embodiment, the raw material powder may include particle sizes of at least about 0.10 μm, at least about 0.20 μm, at least about 0.25 μm. In another embodiment, the particle sizes of the raw material powder can be within a range comprising any pair of the previous upper and lower limits. In another embodiment, the particle sizes may include a range of at least about 0.10 μm to not greater than about 50 μm, such as at least about 0.20 μm to not greater than about 40 μm, such as at least about 0.20 μm to not greater than about 30 μm, such as at least about 0.20 μm to not greater than about 0.25 μm.

The raw material powder may also include a mean (average) particle size that falls within the range of upper and lower particle sizes discussed above. In one embodiment, the raw material powder may include a mean particle size of not greater than about 5 μm, not greater than about 4 μm. In another embodiment, the raw material powder may include a mean particle size of at least about 2 μm, at least about 3 μm. In an embodiment, the mean particle size of the raw material powder can be within a range comprising any pair of the previous upper and lower limits. In an embodiment, the mean particle size can be in a range of at least about 2 μm to not greater than about 5 μm, such as at least about 3 μm to not greater than about 4 μm.

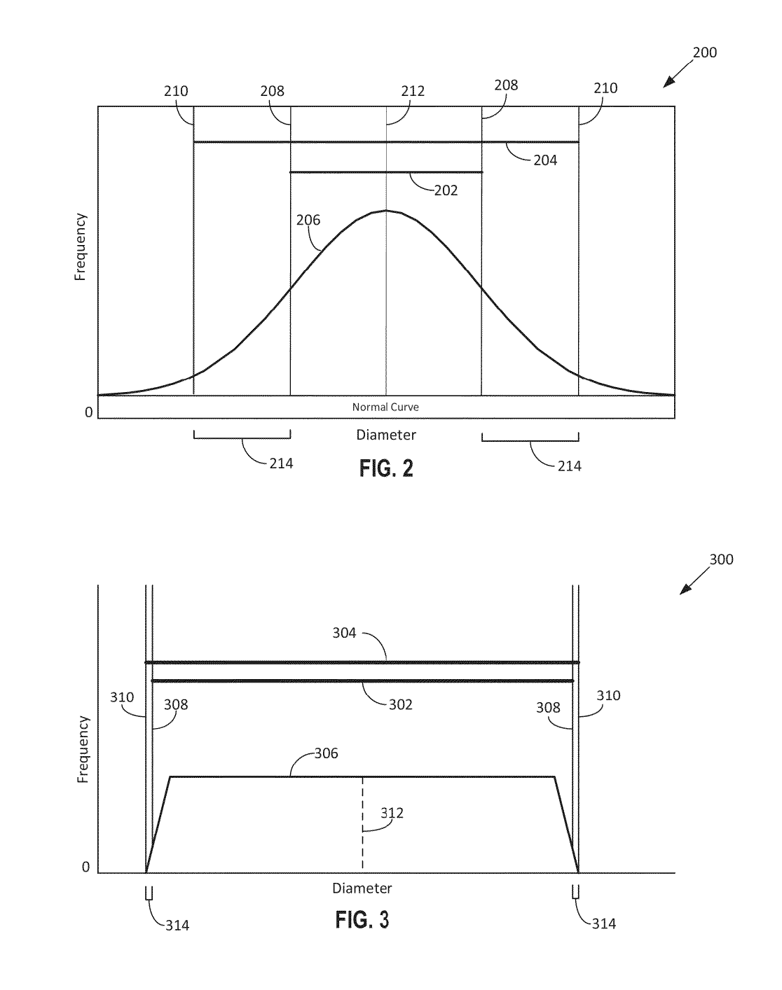

The raw material powder may include a particle size distribution of the particles comprising the powder. The particle size distribution can be defined by the number of particles within one or more standard deviations from the mean (particle size). FIG. 2 illustrates a plotted curve of frequency versus diameter size of particles of a general raw material powder. As shown in FIG. 2, graph 200 illustrates a plotted curve 206 of a general particle size distribution having a normal distribution curve. Typically, a normal, or Gaussian, distribution is defined as having about 68% of all values within one standard deviation from the mean, and about 95% of all values within two standard deviations from the mean. FIG. 2 illustrates mean 212, first standard deviation 208, and second standard deviation 210. The area under the curve 206 between first standard deviations 208 on either side of the mean 212 represents 68% of all particles of the general raw material powder. The area under the curve 206 between second standard deviations 210 on either side of the mean 212 represents 95% of all particles of the general raw material powder. Additionally, bar 202 represents the range of all diameter values within the first standard deviations 208 of the mean 212, and bar 204 represents the range of all diameter values within the second standard deviations 210 of the mean 212.

Further, a particle size distribution of a raw material powder can also be defined by the difference (in % of the total number of particles of the raw material powder) between the first standard deviation and the second standard deviation. FIG. 2 illustrates this difference as the cumulative values of reference numerals 214 on either side of the mean 212, illustrating the difference between first standard deviations 208 and second standard deviations 210. In a normal, or Gausian, curve or distribution, the difference 214 between the first standard deviation of 68% and the second standard deviation of 95% is 27%.

In an embodiment, the raw material powder may include a particle size distribution that is non-Gausian, or non-normal. In particular, the raw material powder of one embodiment may include a raw material powder having a broad particle size distribution (BPSD). FIG. 3 includes an illustration of a plotted curve of frequency versus diameter size of particles of a raw material powder having a BPSD. As shown in FIG. 3, graph 300 illustrates a plotted curve 306 of a particle size distribution having a broad particle size distribution (BPSD). In contrast to a normal distribution, as discussed above, that includes about 68% of all values within one standard deviation from the mean, a BPSD may be defined as having greater than 68% of all values within one standard deviation from the mean. FIG. 3 illustrates the first standard deviations 308 on either side of the mean 312, and second standard deviations 310 on either side of the mean 312. The area under the curve 306 between first standard deviations 308 on either side of the mean 312 represents greater than 68% of all particles of the raw material powder having a BPSD. Bar 302 represents at least about 68% of all values within the first standard deviation 308 of the mean 312. In an embodiment, the raw material powder may have a broad particle size distribution (BPSD) can be defined by a first standard deviation that includes at least about 78% of a total number of particles of the raw material powder. In another embodiment, the raw material powder can have a particle size distribution having a first standard deviation that includes at least about 80%, at least about 85%, at least about 90%, at least about 95%, at least about 97%, at least about 98%, or even at least about 99% of the total number of particles of the raw material powder. In another embodiment, the raw material powder can have a particle size distribution having a first standard deviation that includes not greater than about 99%, not greater than about 98%, not greater than about 97%, not greater than about 95%, not greater than about 90%, not greater than about 85%, or even not greater than about 80% of the total number of particles of the raw material powder. In another embodiment, the raw material powder can have a particle size distribution of the total number of particles of the raw material powder within a range comprising any pair of the previous upper and lower limits.

An embodiment of a raw material powder having a broad particle size distribution (BPSD) can also be defined by the number of particles within two standard deviations, i.e., a second standard deviation, from the mean (particle size). In contrast to a normal distribution which includes about 95% of all values within two standard deviations from the mean, a BPSD may be defined as having greater than 95% of all values within two standard deviations, i.e., the second standard deviation, from the mean. As shown in FIG. 3, the area under the curve 306 within two standard deviations from the mean (i.e. between second standard deviations 310 on either side of the mean 312) represents greater than 95% of all particles of the raw material powder having a BPSD. Additionally, bar 304 represents the range of all diameter values within the second standard deviations 310 of the mean 312. In an embodiment, the raw material powder has a particle size distribution, such as a BPSD, having a second standard deviation that includes at least about 98% of a total number of particles of the raw material powder, at least about 99%, about essentially 100% of the total number of particles of the raw material powder.

An embodiment of a raw material powder having a broad particle size distribution (BPSD) can also be defined by the difference (in % of the total number of particles of the raw material powder) between the first standard deviation and the second standard deviation. FIG. 3 illustrates this difference as the cumulative values of reference numerals 314 on either side of the mean 312, illustrating the difference between first and second standard deviations (i.e. first standard deviations 308 and second standard deviations 310). In contrast to the difference between the first and second standard deviations in a Gausian, or normal, curve or distribution, an embodiment of a non-normal, or non-Guasian, curve or distribution may include a difference 314 between the first and second standard deviations that is less than 27%. According to an embodiment, the difference 314 between the first standard deviation and the second standard deviation can be less than 27%, such as less than about 17%, less than about 15%, less than about 12%, less than about 10%, less than about 8%, less than about 5%, less than about 3%, or even less than about 1% of the total number of particles of the raw material powder.

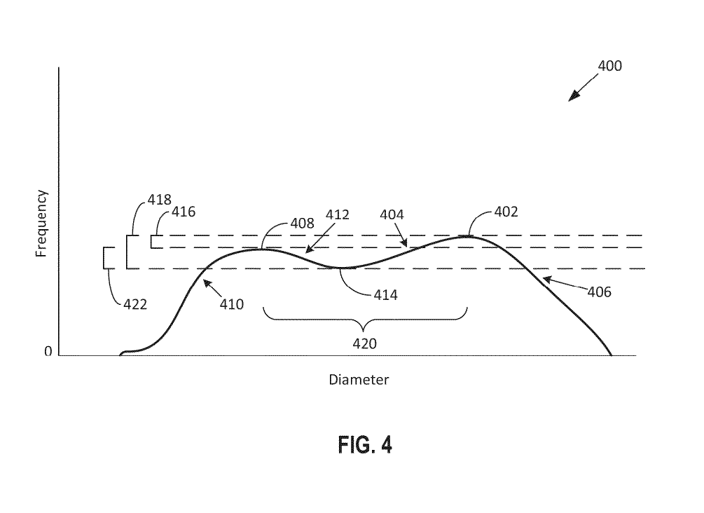

An embodiment of a raw material powder of a broad particle size distribution (BPSD) can also be defined by maximum and minimum frequency values on a plotted curve of the raw material powder versus diameter size of the particles of the raw material powder. FIG. 4 illustrates graph 400 of an embodiment of a raw material powder having a broad particle size distribution (BPSD) defined as a plotted curve of frequency values versus diameter size of the particles of the raw material powder.

In an embodiment, the plotted curve of the BPSD may include a first maximum frequency value, F1ₘₐₓ. F1ₘₐₓ is defined as a point on the plotted curve having a tangent line having a slope of 0, and is located between a first portion of the plotted curve having a positive slope and a second portion of the plotted curve having a negative slope, the first portion being adjacent to the second portion and closer to the origin than the second portion. FIG. 4 shows F1ₘₐₓ 402 located between a first portion 404 of the plotted curve having a positive slope, and a second portion 406 of the plotted curve having a negative slope. As illustrated in FIG. 4, first portion 404 is adjacent to second portion 406 and is closer to the origin (i.e. 0) than second portion 406.

In an embodiment, F1ₘₐₓ can have a frequency value of not greater than about 9%, not greater than about 8%, not greater than about 7%, not greater than about 6%, or not greater than about 5%. In an embodiment, F1ₘₐₓ can have a frequency value of at least about 1%, at least about 2%, at least about 3%, at least about 4%. In an embodiment, F1ₘₐₓ can have a frequency value within a range comprising any pair of the previous upper and lower limits. In a particular embodiment, F1ₘₐₓ can have a frequency value in a range of at least about 1% to not greater than about 9%, such as at least about 2% to not greater than about 8%, such as at least about 3% to not greater than about 7%, such as at least about 4% to not greater than about 6%, such as at least about 4% to not greater than about 5%.

An embodiment of a raw material powder having a broad particle size distribution (BPSD) defined as a plotted curve of frequency values versus diameter size of the particles of the raw material powder may also be characterized as including a second maximum frequency value, F2ₘₐₓ. F2ₘₐₓ is defined as a point on the plotted curve different from F1ₘₐₓ and is further defined as having a tangent line having a slope of 0, and located between a third portion of the plotted curve having a positive slope and a fourth portion of the plotted curve having a negative slope. The third portion is adjacent to the fourth portion and closer to the origin than the fourth portion. FIG. 4 shows F2ₘₐₓ 408 located between third portion 410 of the plotted curve having a positive slope, and a fourth portion 412 of the plotted curve having a negative slope. As illustrated in FIG. 4, third portion 410 is adjacent to fourth portion 412 and is closer to the origin than second portion 412.

In an embodiment, F2ₘₐₓ can be a frequency value of not greater than about 9%, not greater than about 8%, not greater than about 7%, not greater than about 6%, or not greater than about 5%. In an embodiment, F2ₘₐₓ is a frequency value of at least about 1%, at least about 2%, at least about 3%, or at least about 4%. In an embodiment, F2ₘₐₓ can be within a range comprising any pair of the previous upper and lower limits. In a particular embodiment, F2ₘₐₓ can be in a range of at least about 1% to not greater than about 9%, such as at least about 2% to not greater than about 8%, such as at least about 3% to not greater than about 7%, such as at least about 4% to not greater than about 6%, such as at least about 4% to not greater than about 5%.

An embodiment of a raw material powder having a broad particle size distribution (BPSD) defined as a plotted curve of frequency values versus diameter size of the particles of the raw material powder may also be characterized as including a first frequency difference (Δₘₐₓ). The first frequency difference (Δₘₐₓ) is defined as a frequency value of the difference between F1ₘₐₓ and F2ₘₐₓ, such that:

Δₘₐₓ=(F1ₘₐₓ−F2ₘₐₓ).

FIG. 4 illustrates Δₘₐₓ as reference numeral 416, representing the difference between F1ₘₐₓ 402 and F2ₘₐₓ 408. In one embodiment, Δₘₐₓ may be not greater than about 15%, not greater than about 12%, not greater than about 10%, not greater than about 9%, not greater than about 8%, not greater than about 7%, not greater than about 6%, not greater than about 5%, not greater than about 4%, not greater than about 3%, not greater than about 2.5%, not greater than about 2%, or not greater than about 1.5%. In another embodiment, Δₘₐₓ may be at least about 0.1%, at least about 0.3%, at least about 0.5%, at least about 0.8%, at least about 1%. In another embodiment, Δₘₐₓ can be within a range comprising any pair of the previous upper and lower limits. In a particular embodiment, Δₘₐₓ can be in a range of at least about 0.1% to not greater than about 15%, such as at least about 0.3% to not greater than about 12%, such as at least about 0.5% to not greater than about 10%, such as at least about 0.8% to not greater than about 9%, such as at least about 1% to not greater than about 8%, such as at least about 1% to not greater than about 7%, such as at least about 1% to not greater than about 6%, such as at least about 1% to not greater than about 5%, such as at least about 1% to not greater than about 4%, such as at least about 1% to not greater than about 3%, such as at least about 1% to not greater than about 2.5%, such as at least about 1% to not greater than about 2%, such as at least about 1% to not greater than about 1.5%.

The raw material powder having a broad particle size distribution (BPSD) defined as a plotted curve of frequency values versus diameter size of the particles of the raw material powder may also be characterized as including a first minimum frequency value, F1ₘᵢₙ. FIG. 4 illustrates F1ₘᵢₙ as point 414 located between portion 412 and portion 404. In an embodiment, F1ₘᵢₙ is defined as a point on the plotted curve having a tangent line having a slope of 0, and located between a first portion of the plotted curve having a negative slope and a second portion of the plotted curve having a positive slope. As shown in FIG. 4, portion 412 includes a negative slope, while portion 404 includes a positive slope. Portion 412 is adjacent to portion 404 and closer to the origin than portion 404.

The raw material powder having a broad particle size distribution (BPSD) defined as a plotted curve of frequency values versus diameter size of the particles of the raw material powder may also be characterized as having a BPSD that includes a local region. FIG. 4 illustrates local region 420. In an embodiment, the local region is a portion of the plotted curve between the first maximum frequency value and the second maximum frequency value, and further includes at least one minimum frequency value between the first and second maximum frequency values. In a particular embodiment, the local region is defined as a portion of the plotted curve between the first maximum frequency value, F1ₘₐₓ, and the second maximum frequency value, F2ₘₐₓ, and further includes at least one minimum frequency value, F1ₘᵢₙ, between F1ₘₐₓ and F2ₘₐₓ. FIG. 4 illustrates local region 420 as including F1ₘₐₓ 402, F2ₘₐₓ 408, and F1ₘᵢₙ 414.

In an embodiment of a raw material powder having a broad particle size distribution (BPSD) defined as a plotted curve of frequency values versus diameter size of the particles of the raw material powder, and including a local region, F1ₘₐₓ may define a point on the plotted curve having a tangent line having a slope of 0, and located between a first portion of the plotted curve having a positive slope and a second portion of the plotted curve having a negative slope, the first portion being adjacent to the second portion and closer to the origin than the second portion; F2ₘₐₓ is different from F1ₘₐₓ and defines a point on the plotted curve having a tangent line having a slope of 0, and located between a third portion and a fourth portion; and F1ₘᵢₙ defines a point on the plotted curve having a tangent line having a slope of 0, and located between the third portion and the second portion. In a particular embodiment, F1ₘᵢₙ is at least about 1%, at least about 2%, at least about 3%, or at least about 4%.

The raw material powder having a broad particle size distribution (BPSD) defined as a plotted curve of frequency values versus diameter size of the particles of the raw material powder, may also be characterized as including an a second frequency difference, Δₘᵢₙ. FIG. 4 illustrates Δₘᵢₙ as reference numeral 418, representing the difference between F1ₘₐₓ 402 and F1ₘᵢₙ 414. Δₘᵢₙ is defined as the difference between F1ₘₐₓ and F1ₘᵢₙ, such that:

Δₘᵢₙ=(F1ₘₐₓ−F1ₘᵢₙ).

In an embodiment, Δₘᵢₙ is not greater than about 8%, not greater than about 7%, not greater than about 6%, not greater than about 5%, not greater than 4%, not greater than 3%, not greater than about 2%, not greater than about 1.5%. In an embodiment, Δₘᵢₙ is at least about 0.1%, at least about 0.3%, at least about 0.5%, at least about 0.8%, at least about 1%. In an embodiment, Δₘᵢₙ can be within a range comprising any pair of the previous upper and lower limits. In a particular embodiment, Δₘᵢₙ can be in a range of at least about 0.1% to not greater than about 8%, such as at least about 0.3% to not greater than 7%, such as at least about 0.5% to not greater than 6%, such as at least about 0.8% to not greater than about 5%, such as at least about 1% to not greater than about 4%, such as at least about 1% to not greater than about 3%, such as at least about 1% to not greater than about 2%, such as at least about 1% to not greater than about 1.5%.

The raw material powder having a broad particle size distribution (BPSD) defined as a plotted curve of frequency values versus diameter size of the particles of the raw material powder, may also be characterized by a third frequency difference, Δ_{diff}. FIG. 4 illustrates Δ_{diff} as reference numeral 422, representing the difference between Δₘᵢₙ 418 and Δₘₐₓ 416. Δ_{diff} is defined as the difference between Δₘᵢₙ and Δₘₐₓ, such that:

Δ_{diff}=(Δₘᵢₙ−Δₘₐₓ).

In an embodiment, Δ_{diff} is not greater than about 6%, not greater than about 5%, not greater than about 4%, not greater than about 3%, not greater than about 2%, not greater than about 1%, not greater than about 0.8%, not greater than about 0.5%, not greater than about 0.3%, not greater than about 0.1%, not greater than about 0.05%.

In an embodiment, a functional layer of a SOFC (e.g., an anode functional layer or a cathode functional layer) is formed from a raw material powder having a BPSD according to one or more of the embodiments described herein. It should also be understood that the present invention is directed to a BPSD that may be used in any layer of an SOFC, such as a cathode bulk layer, a cathode functional layer, an anode bulk layer, and anode functional layer, an electrolyte layer, or an interconnect layer, for example. A SOFC having one or more layers formed by the raw material powder having BPSD according to any of the herein described embodiments possesses a surprisingly low degradation over time (e.g., thermal cycles) as compared to a SOFC having one or more layers formed by raw material powder that does not have a BPSD as described in the embodiments herein.

Items

Item 1. A raw material powder configured to form a portion of a layer of a solid oxide fuel cell comprising a broad particle size distribution (BPSD) defined by a plotted curve of frequency versus diameter size of the particles of the raw material powder, wherein the BPSD is defined by a first standard deviation including at least about 78% of a total number of particles of the raw material powder.

Item 2. The raw material powder of item 1, wherein the first standard deviation includes at least about 80%, at least about 85%, at least about 90%, at least about 95%, at least about 97%, at least about 98%, at least about 99% of the total content of particles of the raw material powder.

Item 3. The raw material powder of item 1, wherein the BPSD is defined by a second standard deviation including at least about 98%, at least about 99%, about 100% of the total content of particles of the raw material powder.

Item 4. The raw material powder of item 3, wherein the difference between the first standard deviation and the second standard deviation is less than about 17%, less than about 15%, less than about 12%, less than about 10%, less than about 8%, less than about 5%, less than about 3%, less than about 1%.

Item 5. The raw material powder of item 1, wherein the BPSD includes a first maximum frequency value, F1ₘₐₓ, defining a point on the plotted curve having a tangent line having a slope of 0, and located between a first portion of the plotted curve having a positive slope and a second portion of the plotted curve having a negative slope, the first portion being adjacent to the second portion and closer to the origin than the second portion.

Item 6. The raw material powder of item 5, wherein F1ₘₐₓ is not greater than about 9%, not greater than about 8%, not greater than about 7%, not greater than about 6%, not greater than about 5%, and wherein F1ₘₐₓ is at least about 1%, at least about 2%, at least about 3%, at least about 4%.

Item 7. The raw material powder of item 1, wherein the BPSD includes a second maximum frequency value, F2ₘₐₓ, different from F1ₘₐₓ and defining a point on the plotted curve having a tangent line having a slope of 0, and located between a third portion of the plotted curve having a positive slope and a fourth portion of the plotted curve having a negative slope, the third portion being adjacent to the fourth portion and closer to the origin than the fourth portion.

Item 8. The raw material powder of item 7, wherein F2ₘₐₓ is not greater than about 9%, not greater than about 8%, not greater than about 7%, not greater than about 6%, not greater than about 5%, and wherein F2ₘₐₓ is at least about 1%, at least about 2%, at least about 3%, at least about 4%.

Item 9. The raw material powder of item 7, wherein a first frequency difference, Δₘₐₓ, is not greater than about 15%, not greater than about 12%, not greater than about 10%, not greater than about 9%, not greater than about 8%, not greater than about 7%, not greater than about 6%, not greater than about 5%, not greater than about 4%, not greater than about 3%, not greater than about 2.5%, not greater than about 2%, not greater than about 1.5%, and wherein Δₘₐₓ is at least about 0.1%, at least about 0.3%, at least about 0.5%, at least about 0.8%, at least about 1%.

Item 10. The raw material powder of item 1, wherein the BPSD includes a first minimum frequency value, F1ₘᵢₙ, defining a point on the plotted curve having a tangent line having a slope of 0, and located between a first portion of the plotted curve having a negative slope and a second portion of the plotted curve having a positive slope, the third portion being adjacent to the fourth portion and closer to the origin than the fourth portion.

Item 11. The raw material powder of item 1, wherein the BPSD further includes a local region, the local region defining a portion of the plotted curve between a first maximum frequency value, F1ₘₐₓ, and a second maximum frequency value, F2ₘₐₓ, and further comprising at least one minimum frequency value, F1ₘᵢₙ, between F1ₘₐₓ and F2ₘₐₓ, wherein;
F1ₘₐₓ defines a point on the plotted curve having a tangent line having a slope of 0, and located between a first portion of the plotted curve having a positive slope and a second portion of the plotted curve having a negative slope, the first portion being adjacent to the second portion and closer to the origin than the second portion;
F2ₘₐₓ is different from F1ₘₐₓ and defines a point on the plotted curve having a tangent line having a slope of 0, and located between a third portion of the plotted curve having a positive slope and a fourth portion of the plotted curve having a negative slope, the third portion being adjacent to the fourth portion and closer to the origin than the fourth portion; and
F1ₘᵢₙ defines a point on the plotted curve having a tangent line having a slope of 0, and located between the third portion and the second portion.

Item 12. The raw material powder of item 10, wherein F1ₘᵢₙ is at least about 1%, at least about 2%, at least about 3%, at least about 4%.

Item 13. The raw material powder of item 10, wherein a second frequency difference, Δₘᵢₙ, is not greater than about 8%, not greater than about 7%, not greater than about 6%, not greater than about 5%, not greater than 4%, not greater than 3%, not greater than about 2%, not greater than about 1.5%, and wherein Δₘᵢₙ is at least about 0.1%, at least about 0.3%, at least about 0.5%, at least about 0.8%, at least about 1%.

Item 14. The raw material powder of item 13, wherein the third frequency difference, Δ_{diff}, is not greater than about 6%, not greater than about 5%, not greater than about 4%, not greater than about 3%, not greater than about 2%, not greater than about 1%, not greater than about 0.8%, not greater than about 0.5%, not greater than about 0.3%, not greater than about 0.1%, not greater than about 0.05%.

Item 15. The raw material powder of item 1, wherein the raw material powder includes particle sizes not greater than about 50 μm, not greater than about 40 μm, not greater than about 30 μm, not greater than about 20 μm.

Item 16. The raw material powder of item 1, wherein the raw material powder includes particle sizes of at least about 0.20 μm, at least about 0.25 μm.

Item 17. The raw material powder of item 1, wherein the raw material powder includes a mean particle size of not greater than about 5 μm, not greater than about 4 μm, and wherein raw material powder includes a mean particle size of at least about 2 μm, at least about 3 μm.

Item 18. The raw material powder of item 1, wherein the raw material powder includes yttria stabilized zirconia (YSZ).

Item 19. The raw material powder of item 1, wherein the raw material powder includes one or more materials chosen from the group consisting of nickel and nickel oxide.

Item 20. The raw material powder of item 1, wherein the portion of a layer of a solid oxide fuel cell is an anode functional layer (AFL).

### EXAMPLES

A raw material powder (powder A) was obtained and determined to have the following particle sizes and frequencies of particles sizes as shown in TABLE 1 below.

TABLE 1
(POWDER A)

| Diameter | Frequency |
|---|---|
| [μm] | [%] |
| 0.226 | 0.117 |
| 0.259 | 0.262 |
| 0.296 | 0.607 |
| 0.339 | 1.337 |
| 0.389 | 2.569 |
| 0.445 | 4.375 |
| 0.51 | 6.35 |
| 0.584 | 8.293 |
| 0.669 | 9.488 |
| 0.766 | 9.669 |
| 0.877 | 9.755 |
| 1.005 | 9.553 |
| 1.151 | 9.05 |
| 1.318 | 8.182 |
| 1.51 | 6.884 |
| 1.729 | 5.271 |
| 1.981 | 3.653 |
| 2.269 | 2.245 |
| 2.599 | 1.286 |
| 2.976 | 0.635 |
| 3.409 | 0.285 |
| 3.905 | 0.131 |

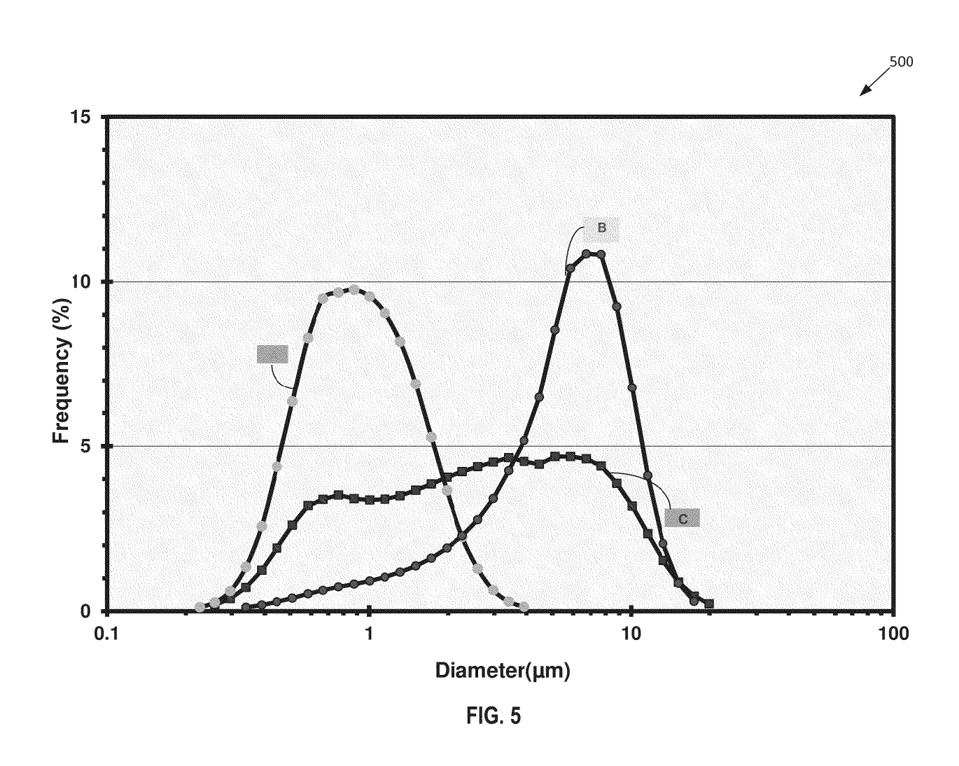

FIG. 5 shows the plotted curve of frequency (%) versus diameter (in log values of μm) of powder A. As can be seen in FIG. 5, powder A tends to have a near-Gaussian distribution.

A raw material powder (powder B) was obtained and determined to have the following particle sizes and frequencies of particles sizes as shown in TABLE 2 below.

TABLE 2
(POWDER B)

| Diameter | Frequency |
|---|---|
| [μm] | [%] |
| 0.339 | 0.115 |
| 0.389 | 0.183 |
| 0.445 | 0.278 |
| 0.51 | 0.394 |
| 0.584 | 0.522 |
| 0.669 | 0.629 |
| 0.766 | 0.738 |
| 0.877 | 0.82 |
| 1.005 | 0.916 |
| 1.151 | 1.033 |
| 1.318 | 1.181 |
| 1.51 | 1.371 |
| 1.729 | 1.607 |
| 1.981 | 1.909 |
| 2.269 | 2.283 |
| 2.599 | 2.769 |
| 2.976 | 3.41 |
| 3.409 | 4.256 |
| 3.905 | 5.167 |
| 4.472 | 6.482 |
| 5.122 | 8.54 |
| 5.867 | 10.407 |
| 6.72 | 10.844 |
| 7.697 | 10.825 |
| 8.816 | 9.245 |
| 10.097 | 6.777 |
| 11.565 | 4.106 |
| 13.246 | 2.048 |
| 15.172 | 0.848 |
| 17.377 | 0.297 |

FIG. 5 shows the plotted curve of frequency (%) versus diameter (in log values of μm) of powder B. As can be seen in FIG. 5, powder B also tends to have a near-Gaussian distribution, with a slight negative skew.

A raw material powder (powder C) was prepared and determined to have the following particle sizes and frequencies of particles sizes as shown in TABLE 3 below.

TABLE 3
(POWDER C)

| Diameter | Frequency |
|---|---|
| [μm] | [%] |
| 0.259 | 0.192 |
| 0.296 | 0.377 |
| 0.339 | 0.715 |
| 0.389 | 1.24 |
| 0.445 | 1.913 |
| 0.51 | 2.606 |
| 0.584 | 3.196 |
| 0.669 | 3.385 |
| 0.766 | 3.516 |
| 0.877 | 3.403 |
| 1.005 | 3.366 |
| 1.151 | 3.391 |
| 1.318 | 3.494 |
| 1.51 | 3.662 |
| 1.729 | 3.85 |
| 1.981 | 4.055 |
| 2.269 | 4.223 |
| 2.599 | 4.374 |
| 2.976 | 4.518 |
| 3.409 | 4.653 |
| 3.905 | 4.536 |
| 4.472 | 4.447 |
| 5.122 | 4.686 |
| 5.867 | 4.687 |
| 6.72 | 4.619 |
| 7.697 | 4.401 |
| 8.816 | 3.869 |
| 10.097 | 3.184 |
| 11.565 | 2.349 |
| 13.246 | 1.535 |
| 15.172 | 0.884 |
| 17.377 | 0.449 |
| 19.904 | 0.224 |

FIG. 5 shows the plotted curve of frequency (%) versus diameter (in log values of μm) of powder C. As can be seen in FIG. 5, powder C tends to have a broad particle size distribution in accordance with the embodiments described herein.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A raw material powder configured to form a portion of a layer of a solid oxide fuel cell comprising a broad particle size distribution (BPSD) defined by a plotted curve of frequency versus diameter size of the particles of the raw material powder, wherein the BPSD is defined by a first standard deviation including at least about 78% of a total number of particles of the raw material powder.

2. The raw material powder of claim 1, wherein the first standard deviation includes at least about 80% of the total content of particles of the raw material powder.

3. The raw material powder of claim 1, wherein the BPSD is defined by a second standard deviation including at least about 98% of the total content of particles of the raw material powder.

4. The raw material powder of claim 3, wherein the difference between the first standard deviation and the second standard deviation is less than about 17%.

5. The raw material powder of claim 1, wherein the BPSD includes a first maximum frequency value, F1ₘₐₓ, defining a point on the plotted curve having a tangent line having a slope of 0, and located between a first portion of the plotted curve having a positive slope and a second portion of the plotted curve having a negative slope, the first portion being adjacent to the second portion and closer to the origin than the second portion.

6. The raw material powder of claim 5, wherein F1ₘₐₓ is not greater than about 9%, and wherein F1ₘₐₓ is at least about 1%.

7. The raw material powder of claim 1, wherein the BPSD includes a second maximum frequency value, F2ₘₐₓ, different from F1ₘₐₓ and defining a point on the plotted curve having a tangent line having a slope of 0, and located between a third portion of the plotted curve having a positive slope and a fourth portion of the plotted curve having a negative slope, the third portion being adjacent to the fourth portion and closer to the origin than the fourth portion.

8. The raw material powder of claim 7, wherein F2ₘₐₓ is not greater than about 9%, and wherein F2ₘₐₓ is at least about 1%.

9. The raw material powder of claim 7, wherein a first frequency difference, Δₘₐₓ, is not greater than about 15%, and wherein Δₘₐₓ is at least about 0.1%.

10. The raw material powder of claim 1, wherein the BPSD includes a first minimum frequency value, F1ₘᵢₙ, defining a point on the plotted curve having a tangent line having a slope of 0, and located between a first portion of the plotted curve having a negative slope and a second portion of the plotted curve having a positive slope, the third portion being adjacent to the fourth portion and closer to the origin than the fourth portion.

11. The raw material powder of claim 1, wherein the BPSD further includes a local region, the local region defining a portion of the plotted curve between a first maximum frequency value, F1ₘₐₓ, and a second maximum frequency value, F2ₘₐₓ, and further comprising at least one minimum frequency value, F1ₘᵢₙ, between F1ₘₐₓ and F2ₘₐₓ, wherein;
F1ₘₐₓ defines a point on the plotted curve having a tangent line having a slope of 0, and located between a first portion of the plotted curve having a positive slope and a second portion of the plotted curve having a negative slope, the first portion being adjacent to the second portion and closer to the origin than the second portion;
F2ₘₐₓ is different from F1ₘₐₓ and defines a point on the plotted curve having a tangent line having a slope of 0, and located between a third portion of the plotted curve having a positive slope and a fourth portion of the plotted curve having a negative slope, the third portion being adjacent to the fourth portion and closer to the origin than the fourth portion; and
F1ₘᵢₙ defines a point on the plotted curve having a tangent line having a slope of 0, and located between the third portion and the second portion.

12. The raw material powder of claim 10, wherein F1ₘᵢₙ is at least about 1%.

13. The raw material powder of claim 10, wherein a second frequency difference, Δₘᵢₙ, is not greater than about 8%, and wherein Δₘᵢₙ is at least about 0.1%.

14. The raw material powder of claim 13, wherein the third frequency difference, Δ_{diff}, is not greater than about 6%.

15. The raw material powder of claim 1, wherein the raw material powder includes particle sizes not greater than about 50 μm.

16. The raw material powder of claim 1, wherein the raw material powder includes particle sizes of at least about 0.20 μm.

17. The raw material powder of claim 1, wherein the raw material powder includes a mean particle size of not greater than about 5 μm, and at least about 2 μm.

18. The raw material powder of claim 1, wherein the raw material powder includes yttria stabilized zirconia (YSZ).

19. The raw material powder of claim 1, wherein the raw material powder includes one or more materials chosen from the group consisting of nickel and nickel oxide.

20. The raw material powder of claim 1, wherein the portion of a layer of a solid oxide fuel cell is an anode functional layer (AFL).
